(19) United States
(12) Patent Application Publication
(10) Pub. No.: US 2002/0190781 A1
(43) Pub. Date: Dec. 19, 2002

(54) Charge pump circuit and use of a charge pump circuit

(75) Inventor: Matthias Von Daak, Muenchen (DE)

Correspondence Address: EDWARDS & ANGELL, LLP., P.O. BOX 9169, BOSTON, MA, 02209, US

(73) Assignee: Infineon Technologies AG, Germany

(21) Appl. No.: 10/156,426

(22) Filed: May 28, 2002

(30) Foreign Application Priority Data
May 28, 2001 (EP) 01 112 080.5

(51) Int. Cl. G05F 1/10

(52) U.S. Cl. 327/536

(57) ABSTRACT

In order to reduce the surface area of a charge pump of a memory module, in particular a non-volatile memory, needed to generate the erasing high voltage (V_{ERASE}) and the programming high voltage (V_{PROG}), a charge pump with several pump stages (1) connected in series is proposed, the charge pump being designed to produce a maximum required output voltage, e.g. the erasing high voltage (V_{ERASE}), and an intermediate tap is provided for generating an additional output voltage, for example the programming high voltage (V_{PROG}). Consequently only one charge pump is needed to generate different high voltages (V_{PROG}, V_{ERASE}) from a single supply voltage (V_{IN}).

The present invention relates to a charge pump circuit having several pump stages, which are needed in memory modules with only one supply voltage (Single Supply Memory) for example, in particular in non-volatile memory modules, to produce the high voltages needed for a programming or erasing procedure.

In every non-volatile memory with only one supply voltage, such as in EEPROM memories (Electrical Erasable Programmable Read Only Memory) or Flash-EEPROM memories for example, charge pumps are needed which generate from the supply voltage the high voltages needed for a programming or erasing procedure of the respective memory. Charge pumps of this type comprise several pump stages connected in series, each of which amplifies the voltage applied to its input in such a way that an output voltage generated by the last pump stage is higher than the supply voltage applied to the first pump stage and can be used for electrically programming or erasing the respective memory. Every pump stage may incorporate what are known as switched capacitors (or SC-technology), whereby, in the simplest of situations, every pump stage is made up of a diode-capacitor combination in which the diode blocks the current in one direction and allows it to pass in the other direction, thereby producing the desired pumping effect.

In conventional charge pumps, the number of pump stages is selected depending on the respective output voltage required. This being the case, every charge pump is designed individually for a specific output voltage.

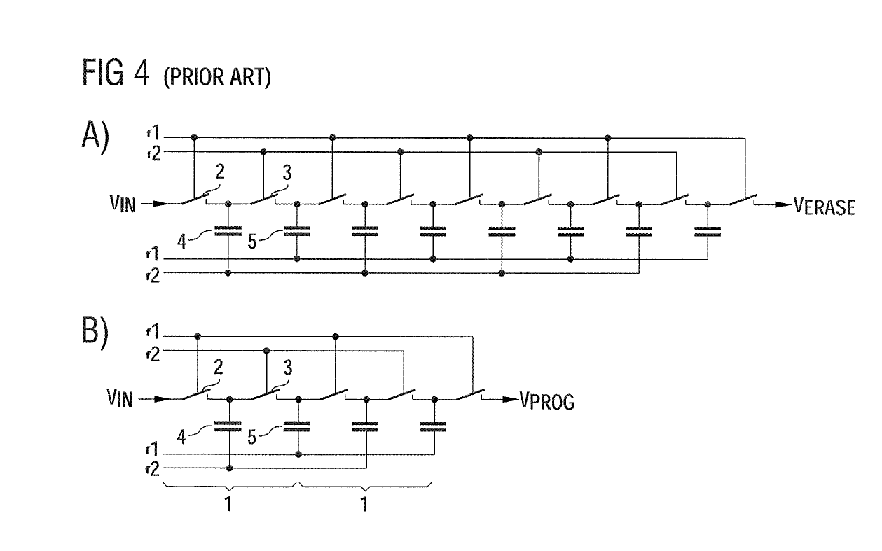

FIGS. 4A and 4B illustrate an example of a conventional charge pump for producing an erasing high voltage V_{ERASE} and a programming-high voltage V_{PROG} from a supply voltage V_{IN}. The charge pump respectively comprises several pump stages 1 connected in series, which in turn respectively comprise capacitors 4, 5 switched by switching means or switching elements 2, 3. The capacitors 4, 5 respectively, and the switching means 2, 3 respectively, are operated with different clock signals, f₁ and f₂, which, as in this particular case, might be two clock signals of the same frequency in phase opposition. The structure of a pump stage 1 of this type operating on this two-phase clocking type of principle is described in patent specification U.S. Pat. No. 6,208,539, for example.

As may be seen from FIG. 4A and FIG. 4B, conventional separate charge pumps with separate pump capacities or pump capacitors 4, 5 are used to generate the erasing high voltage V_{ERASE}, which may be approximately 18V, and the programming high voltage V_{PROG}, which may be approximately 7V, the number of pump stages of each charge pump being adapted to the respective output voltage V_{ERASE} or V_{PROG} required.

Charge pumps take up a significant proportion of the module surface of memory modules and can account for up to 5% of the module surface area of small-capacity memories. This being the case, the surface of charge pumps is dominated respectively by the surface occupied by the pump capacitors 4, 5. In terms of structure, these are determined by the desired output voltages and the desired output current. This surface area taken up by a charge pump is therefore more or less dependent on the technology used and the relative proportion of the charge pump surface to the total memory module surface therefore increases as technological advances enable smaller structural dimensions.

Accordingly, the underlying objective of the present invention is to propose a charge pump circuit and the use of a charge pump circuit, by means of which the space needed to generate different voltages from a supply voltage, in particular an erasing high voltage and a programming high voltage for a memory module, can be reduced.

This objective is achieved by the invention, due to a charge pump circuit having the characterising features of claim 1 and by the use of a charge pump circuit having the characterising features of claim 12. The dependent claims respectively define preferred and advantageous embodiments of the present invention.

For the purpose of the invention, a charge pump circuit is proposed, which is designed to produce a maximum necessary output voltage and part sections of the charge pump circuit are used to generate output voltages that are lower than the maximum output voltage. If the charge pump circuit has n pump stages, for example, it will be possible to provide n−1 intermediate taps for output voltages between two consecutive pump stages, so that in total n−1 output voltages can be tapped off which, on the one hand, are higher than the supply voltage applied to the first pump stage and, on the other, are lower than the maximum output voltage supplied by the last pump stage. Consequently, the invention enables n output voltages that are higher than the supply voltage to be generated with only one charge pump circuit.

The present invention is particularly well suited to generating a programming high voltage and an erasing high voltage for non-volatile memory modules, such as EEPROM or Flash-EEPROM memories from only one supply voltage, and the part of the charge pump circuit which has an intensive space requirement, namely the pump capacitors, can be commonly used to generate both voltages. This is so because use is made of the fact that in every operating mode (erase mode or programming mode), either only the erasing high voltage or the programming high voltage is needed. The charge pump circuit proposed by the invention can also be used to generate auxiliary voltages which are needed in read mode or in programming mode to control high-voltage transfer gates.

The charge pump circuit proposed by the invention may be combined with a control circuit for controlling the individual output voltages. If the charge pump circuit proposed by the invention is also used to generate auxiliary voltages as explained above, these may be left uncontrolled because such auxiliary voltages are not subject to any specific requirements in terms of their precision.

By using the present invention, only a single charge pump circuit specified to the requisite maximum output voltage is needed in all, in order to generate, in addition to this maximum output voltage, other output voltages higher than the supply voltage, including auxiliary voltages, and there is therefore no need to use separate charge pumps to generate different output voltages. Consequently, the surface area of the charge pump needed to produce these different output voltages can be significantly reduced, compared with that required for the prior art systems. In an EEPROM memory with a storage capacity of 72 KB, the gain in surface area is approximately 2.5% (this memory size is typical of that used in chip card applications, for example). However, there are also numerous applications for smaller memory sizes, for example 8 KB or 16 KB storage capacities, in which the relative gain in surface area is correspondingly higher and may be at least 5-15%.

The present invention will be described in more detail below with reference to examples of embodiments illustrated in the appended drawings.

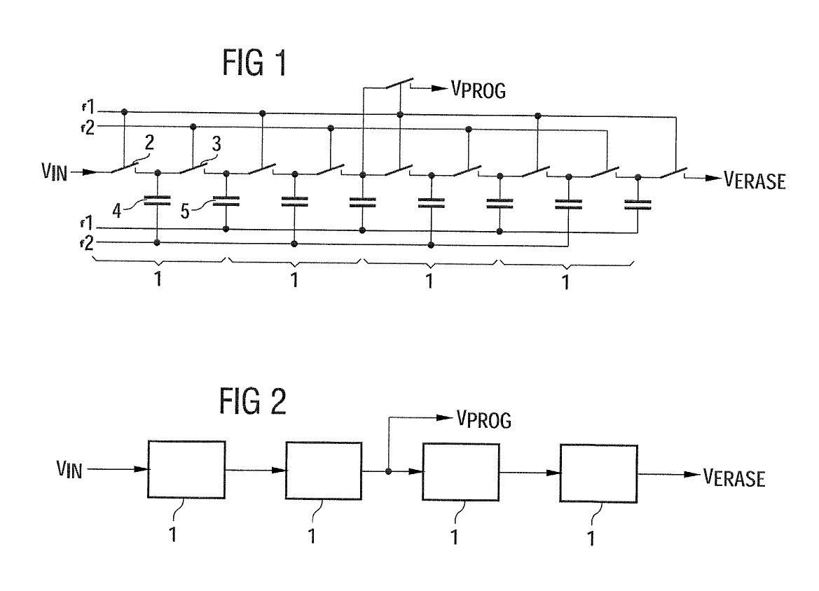

FIG. 1 illustrates a preferred embodiment of a charge pump as proposed by the invention for generating an erasing high voltage and a programming high voltage for a memory module,

FIG. 2 is a schematic and very simplified diagram of the charge pump illustrated in FIG. 1,

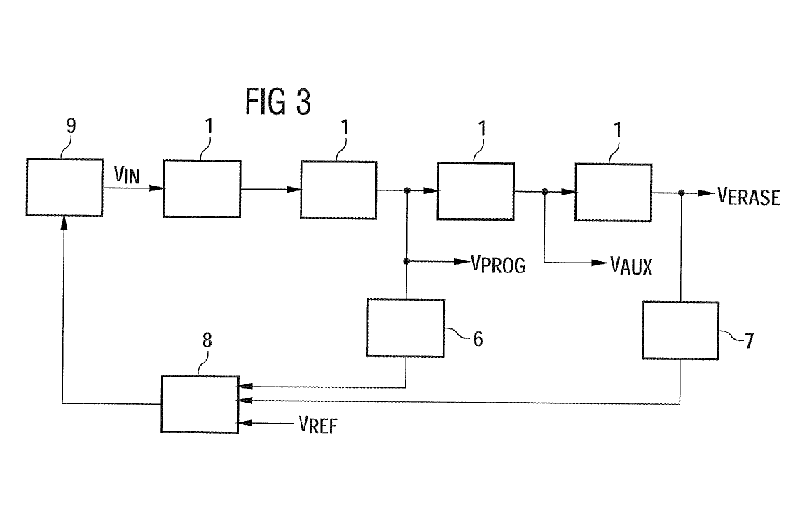

FIG. 3 shows the embodiment illustrated in FIG. 1 and FIG. 2 with a control circuit for regulating the erasing high voltage and the programming high voltage whilst additionally generating an auxiliary voltage, and

FIG. 4A and FIG. 4B show examples of charge pumps known from the prior art for generating an erasing high voltage and a programming high voltage.

The charge pump illustrated in FIG. 1, for example, is suitable for generating an erasing high voltage V_{ERASE} (approximately 18V) for erasing the memory cells of a memory, for example a non-volatile read-only memory, and a programming high voltage V_{PROG} for programming the memory cells of this memory with only one charge pump. The principle used is based on the fact that, in any one operating mode (programming mode or erase mode) either only the erasing high voltage V_{ERASE} or the programming high voltage V_{PROG} is needed and part sections of the illustrated charge pump can therefore be used jointly to generate both voltages.

As illustrated in FIG. 1, the charge pump consists of several pump stages 1 connected in a row or in series and each pump stage amplifies or increases the input voltage applied to it in such a way that a desired maximum output voltage, in this particular case the erasing high voltage V_{ERASE}, is generated by the last pump stage 1, whilst a relatively low supply voltage V_{IN} of the respective memory is applied to the first pump stage 1.

Every pump stage 1 is of what is known as a switched capacitor design or SC technology and accordingly has capacitors 4, 5 switched by switching means or switching elements 2, 3, the switching means 2 and the capacitor 5, respectively the switching means 3 and the capacitor 4 being operated with different clock signals f₁, respectively f₂. In particular, clock signals of the same frequency in phase opposition may be used as clock signals f₁ and f₂ and the switching means 2, 3 may be provided respectively in the form of appropriate diode circuits. The individual pump stages 1 are preferably based on nMOS technology.

As may be seen from FIG. 1, the number of pump stages 1 is selected so that the desired erasing high voltage V_{ERASE} is supplied at the output of the last pump stage 1. Furthermore, a tap is provided on the output of the second pump stage 1, from which a second output voltage, in this particular case the programming high voltage V_{PROG}, can be tapped, which is higher than the supply voltage V_{IN} and lower than the erasing high voltage V_{ERASE}. Both the erasing high voltage V_{ERASE} and the programming high voltage V_{PROG} are provided via the output switch clocked by the clock signal f₁.

The schematic diagram of FIG. 2 depicts the charge pump illustrated in FIG. 1 with several pump stages 1 connected in series and FIG. 2 also depicts the tap of the programming high voltage V_{PROG} at the output of the second pump stage 1. Clearly, other output- and high voltages which are pumped or increased to levels higher than the supply voltage V_{IN} may optionally be tapped from the output of the other pump stages 1.

FIG. 3 shows the charge pump illustrated in FIG. 1 and FIG. 2 but with an additional intermediate tap, in order to generate an additional output voltage from the supply voltage V_{IN}, in this case an auxiliary voltage V_{AUX}. Auxiliary voltages of this type are needed for the read mode and programming mode of memory modules, for example to control or to connect high-voltage transfer gates, such high-voltage transfer gates enabling high voltages to be selectively connected or disconnected from specific function blocks of the respective memory. With the aid of the charge pump illustrated in FIG. 3, therefore, three different high voltages V_{PROG}, V_{AUX} and V_{ERASE} of a single charge pump can be produced using only a single supply voltage V_{IN} provided from a supply voltage source 9, and the charge pump illustrated in FIG. 3 can thus be used to replace three conventional charge pumps.

Furthermore, the charge pump illustrated in FIG. 3 has a control circuit for regulating the programming high voltage V_{PROG} and the erasing high voltage V_{ERASE}. There are no specific requirements on the auxiliary voltage V_{AUX} in terms of accuracy and this auxiliary voltage can be left unregulated. The regulated programming high voltage V_{PROG}, respectively erasing high voltage V_{ERASE} is detected by means of an appropriate voltage divider 6 or 7 and applied to a controller 8, which compares the respectively detected output voltage with a specific reference voltage V_{REF} and activates the supply voltage source 9 depending on it. Accordingly, the supply voltage VIN can be regulated accordingly or alternatively integrated in the pumping action of the charge pump, for example in order to shut down the pumping action on reaching a desired output voltage level, until the output voltage level falls below a specific threshold value.

Of the different output voltages V_{PROG}, V_{AUX} and V_{ERASE} generated in FIG. 3, only one can be regulated to a desired target value and the two other output voltages result from the number of pump stages 1 between the regulated and unregulated output. The circuit configuration of a charge pump illustrated in FIG. 3 is specifically capable of handling all practical requirements in which only one output voltage has to be accurately defined depending on the respective operating mode, such as programming or erasing memory modules, since only one of either the regulated programming high voltage V_{PROG} or the regulated erasing high voltage V_{ERASE} is needed.

1. Charge pump circuit,
having several pumping stages (1) connected in series, wherein every pump stage (1) amplifies an input voltage applied to it so that a first output voltage (V_{ERASE}) is generated by the last pump stage that is higher than the supply voltage (V_{IN}) applied to the first pump stage, characterised in that
at least one tap is provided between two consecutive pump stages (1) in order to supply a second output voltage (V_{PROG}, V_{AUX}) higher than the supply voltage (V_{IN}) which is lower than the first output voltage (V_{ERASE}).

2. Charge pump circuit as claimed in claim 1,
characterised in that the charge pump circuit is configured so that the first output voltage (V_{ERASE}) corresponds to an erasing voltage for erasing a memory module and the second output voltage (V_{PROG}) corresponds to a programming voltage for programming the memory module.

3. Charge pump circuit as claimed in claim 1,
characterised in that
at least one additional tap is provided between two consecutive pump stages (1) to supply an auxiliary voltage (V_{AUX}) that is higher than the supply voltage (V_{IN}).

4. Charge pump circuit as claimed in claim 3,
characterised in that the charge pump circuit is configured so that the auxiliary voltage (V_{AUX}) can be used for switching a transfer gate of a memory module for connecting and disconnecting a high voltage.

5. Charge pump circuit as claimed in claim 1,
characterised in that
a control circuit (7, 8) is provided for regulating the first output voltage (V_{ERASE}).

6. Charge pump circuit as claimed in claim 1,
characterised in that
a control circuit (6, 8) is provided for regulating the second output voltage (V_{PROG}).

7. Charge pump circuit as claimed in claim 5 and claim 6,
characterised in that
the control circuit for regulating the first output voltage (V_{ERASE}) and the control circuit for regulating the second output voltage (V_{PROG}) have a common controller (8).

8. Charge pump circuit as claimed in claim 7,
characterised in that
the controller (8) selectively evaluates the first output voltage (V_{ERASE}) or the second output voltage (V_{PROG}) and, dependent thereon, generates a control signal for the charge pump circuit.

9. Charge pump circuit as claimed in claim 1,
characterised in that
the charge pump circuit is designed as an integrated circuit.

10. Charge pump circuit as claimed in claim 1,
characterised in that
the design of every pump stage (1) is based on SC technology with two-phase clocking operation (f₁, f₂).

11. Memory module,
with a supply voltage terminal for receiving a supply voltage (V_{IN}) and
having a charge pump circuit as claimed in claim 1, the supply voltage (V_{IN}) being applied to the first pump stage (1) of the charge pump circuit.

12. Use of a charge pump circuit,
the charge pump circuit having several pump stages (1) connected in series, wherein every pump stage (1) amplifies the input voltage applied to it and the charge pump circuit is designed to generate a specific maximum required output voltage (V_{ERASE}) such that, from the supply voltage (V_{IN}) applied to the first pump stage, the maximum required output voltage (V_{ERASE}), which is higher than the supply voltage (V_{IN}), is generated by the last pump stage, characterised in that
at least a part section of the charge pump circuit is used to generate another output voltage (V_{PROG}, V_{AUX}) higher than the supply voltage (V_{IN}) that is lower than the maximum required output voltage (V_{ERASE}).

13. Use as claimed in claim 12,
characterised in that
the other output voltage (V_{PROG}, V_{AUX}) is tapped from between two consecutive pump stages (1) of the charge pump circuit.

14. Use as claimed in claim 12,
characterised in that
at least a part section of the charge pump circuit is used to generate an auxiliary voltage (V_{AUX}) higher than the supply voltage (V_{IN}) that is lower than the maximum required output voltage (V_{ERASE}).

15. Use as claimed in claim 14,
characterised in that
the charge pump circuit is used to generate an erase high voltage (V_{ERASE}) for a memory module as the maximum output voltage required, and a programming high voltage (V_{PROG}) for the memory module as the other output voltage, the auxiliary voltage (V_{AUX}) being used to switch a transfer gate of the memory module in order to connect and disconnect a high voltage.

16. Use as claimed in claim 15,
characterised in that the erasing high voltage (V_{ERASE}) and the programming high voltage (V_{PROG}) are regulated, whereas the auxiliary voltage (V_{AUX}) is not regulated.
